(19) United States
(12) Patent Application Publication
(10) Pub. No.: US 2002/0034261 A1
(43) Pub. Date: Mar. 21, 2002

(54) Rate n/n systematic, recursive convolutional encoder and corresponding decoder

(76) Inventors: Donald Brian Eidson, San Diego, CA (US); Abraham Krieger, San Diego, CA (US)

Correspondence Address: HOWREY SIMON ARNOLD & WHILE LLP - SD, 301 RAVENSWOOD AVENUE, MENLO PARK, CA, 94025, US

(21) Appl. No.: 09/887,877

(22) Filed: Jun. 21, 2001

Related U.S. Application Data
(63) Continuation-in-part of application No. 09/602,690, filed on Jun. 23, 2000.

(51) Int. Cl. H04L 27/36

(52) U.S. Cl. 375/298

(57) ABSTRACT

A rate n/n recursive, systematic encoder. In combination with a bit to symbol mapper, the encoder advantageously forms an inner encoder of a serial concatenated trellis coded modulation encoder. The encoder may also form the inner encoder of a serial concatenated convolutional encoder. A related decoder is also described.

This application is a continuation-in-part of U.S. patent application Ser. No. 09/602,690, filed Jun. 23, 2000, which is hereby fully incorporated by reference herein as though set forth in full.

### BACKGROUND OF THE INVENTION

1. Field of the Invention

This invention generally relates to convolutional encoders, and, more specifically, to rate n/n systematic, recursive convolutional encoders for use in serial concatenated coding and serial concatenated trellis coded modulation.

2. Background

Serial concatenated convolutional codes (SCCC) offer the potential of significant coding gains at low bit error rates (BER) compared to conventional coding schemes. SCCC are the topic of several recent patents or publications including U.S. Pat. No. 6,023,783; “Turbo Codes: Analysis, Design, Iterative Decoding and Applications,” Course 909, Part II, International Courses for Telecom and Semiconductor Professionals, S. Benedetto & D. Divsalar, Oct. 25-29, 1999, Barcelona, Spain (hereinafter “Divsalar 1”); “A Serial Concatenation Approach to Iterative Demodulation and Decoding,” K. Narayanan et al., IEEE Transactions on Communications, Vol. 47, No. 7, July 1999; “‘Turbo DPSK’: Iterative Differential PSK Demodulation and Channel Decoding,” P. Hoeher et al., IEEE Transactions on Communications, Vol. 47, No. 6, June 1999; “Serial and Hybrid Concatenated Codes with Applications,” D. Divsalar et al., Proc. Int. Symp. Turbo Codes and Appls., Brest, France, September 1997, pp. 80-87 (hereinafter “Divsalar 2”); “Turbo Trellis Coded Modulation With Iterative Decoding for Mobile Satellite Communications,” D. Divsalar et al., Proc. Int. Mobile Satellite Conf., June 1997 (hereinafter “Divsalar 3”); “Serial Concatenated Trellis Coded Modulation with Iterative Decoding: Design and Performance,” submitted to IEEE Comm. Theory Mini Conference 97 (Globecom 97); “Near Shannon Limit Error-Correcting Coding: Turbo Codes,” C. Berrou et al., Proc. 1993 IEEE International Conference on Communications, Geneva, Switzerland, pp. 1064-1070, May 1993; “A Soft-Input Soft-Output Maximum A Posteriori (MAP) Module to Decode Parallel and Serial Concatenated Codes,” S. Benedetto, TDA Progress Report 42-127, Nov. 12, 1996; and Course 909, Turbo Codes: Analysis, Design, Iterative Decoding and Applications, International Courses For Telecom and Semiconductor Professionals, Oct. 25-29, 1999, Barcelona, Spain, Part II, S. Benedetto and D. Divsalar, pp. 324-339 (hereinafter “Divsalar 4”). Each of these references is hereby fully incorporated by reference herein as though set forth in full.

A rate (2b+1)/(2b+2) convolutional encoder, where b is an integer, is proposed in Divsalar 2 and 3 for the inner encoder in a serial concatenated trellis coded modulation (SCTCM) encoder. The problem is that such an encoder is complex and difficult implement.

In Narayanan et al., a rate 1 differential encoder is proposed for the inner encoder of a SCTCM encoder. Two successive encoded bits are mapped into symbols using π/4-DQPSK modulation. The rate 1 differential encoder of Narayanan is illustrated in FIG. 1A. Input bits are provided as an input to adder 2 over signal line 1. The output 5 of storage element 3 is also provided as an input to adder 2. The sum from the adder 2 is stored in storage element 3.

The rate 1 encoder, while simpler than the rate (2b+1)/(2b+2) encoder of Divsalar, has a problem in that the parallel output of the encoder at a particular point in time is capable of supporting only BPSK or QPSK modulation. Higher order modulation schemes either are not supported, or can be supported only by considering successive outputs of the encoder in a differential mode of operation.

### SUMMARY OF THE INVENTION

In accordance with one aspect of the invention, there is provided a rate n/n recursive, systematic convolutional encoder. The encoder has n inputs, and n outputs, n being an integer greater than 1, wherein (n−1) of the outputs are each derived from a separate one of the n inputs, and the nth output is derived from logic, which may be implemented as hardware, software, or a combination of hardware and software. This logic is configured to receive one or more of the n encoder inputs (and possibly other inputs), and produce the nth output. The logic comprises one or more arithmetic or storage elements coupled together. These elements may be coupled in series, in parallel, or a combination of series and parallel relationships. This logic is configured to provide one or more feedback loops from the nth output (or from some other point within or signal provided by the logic) to one or more of the arithmetic or storage elements. These one or more feedback loops may be characterized by a prime polynomial.

In one embodiment, (n−1) of the encoder inputs are passed through unaltered to form (n−1) of the encoder outputs. Additionally, the logic may comprise an adder and one or more storage elements. One or more feedback loops may be formed from the nth output of the encoder (or some other location within or signal provided by the logic) to the adder and one or more of the storage elements which may be characterized by a prime polynomial. One or more of the n encoder inputs may be input to the adder as may the nth encoder output. Other inputs to the adder are also possible. The nth encoder output may be derived from the output of the adder or one of the storage elements.

In one implementation, the encoder comprises n inputs, n outputs, an adder having n+1 inputs and an output, n being an integer greater than 1, a storage element having an input coupled to the output of the adder and an output coupled to an input of the adder, wherein all n encoder inputs are input to the adder, (n−1) of the encoder inputs are passed through unaltered to form (n−1) of the encoder outputs, and the nth encoder output is derived from the output of the storage element or the adder.

In one application, the rate n/n encoder forms an inner encoder of a SCTCM encoder in which the inner encoder is coupled in series with a bit to symbol mapper in which the order of mapping is a higher order than BPSK. In one implementation example, the bit to symbol mapper is a Gray mapper. The bit to symbol mapper may also be a multi-dimensional mapper in which case the mapper is followed by a multiplexor for serializing the multiple coordinates of each symbol.

A method in accordance with the subject invention comprises the steps of inputting n bits to a rate n/n systematic, recursive convolutional encoder configured in accordance with the invention, wherein n is an integer greater than 1; receiving in parallel from the encoder the resultant n output bits; and mapping the n output bits into a D-dimensional channel symbol, wherein D is an integer of 1 or more, the order of mapping being greater than BPSK. In one implementation, applicable in the case in which D is greater than 1, the method further comprises the step of serializing the D components of the channel symbol, 2 at a time.

Another aspect of the invention is a related decoder configured to decode the encoded symbols as produced by the encoder of the invention. The decoder may be a Viterbi decoder, a SOVA decoder, or a MAP decoder.

### DESCRIPTION OF THE DRAWINGS

FIG. 1A illustrates a conventional rate 1 encoder.

FIG. 1B illustrates a SCCC encoder.

FIG. 1C illustrates an iterative SCCC decoder.

FIG. 2 illustrates a plot of bit error rate (BER) vs. E_{b}/N₀ which is characteristic of SCCC.

FIG. 3A illustrates a first embodiment of a rate 3/3 encoder in accordance with the subject invention.

FIG. 3B illustrates a second embodiment of a rate 3/3 encoder in accordance with the subject invention.

FIG. 4 illustrates an embodiment of a rate 2/2 encoder in accordance with the subject invention.

FIG. 5 illustrates an embodiment of a rate 4/4 encoder in accordance with the subject invention.

FIG. 6 illustrates a SCTCM encoding system in which the inner encoder thereof is an encoder in accordance with the subject invention.

FIGS. 7A-7B illustrate one embodiment of the combination of a rate 3/3 encoder and an 8-PSK symbol mapper in accordance with the subject invention.

FIGS. 8A-8B illustrate one embodiment of the combination of rate 6/6 encoder and a four-dimensional 8-PSK symbol mapper in accordance with the subject invention.

FIGS. 9A-9B illustrate one embodiment of the combination of a rate 4/4 encoder and a 16-QAM symbol mapper in accordance with the subject invention.

FIG. 10 illustrates one embodiment of a method in accordance with the subject invention.

FIG. 11A illustrates a first embodiment of a rate n/n systematic, recursive convolutional encoder configured in accordance with the subject invention.

FIG. 11B illustrates a second embodiment of a rate n/n systematic, recursive convolutional encoder configured in accordance with the subject invention.

FIG. 11C illustrates an implementation of a rate n/n systematic, recursive convolutional encoder configured in accordance with the subject invention.

FIG. 12A illustrates a comparison of the performance of a rate ¾ 8-PSK SCTCM encoder with, respectively, a rate 3/3, a rate 6/6, and a rate 5/6 inner encoder.

FIG. 12B illustrates a comparison of the performance of a rate 5/6 8-PSK SCTCM encoder with, respectively, a rate 3/3, a rate 6/6 inner, and a “best-d2” (JPL) rate 3/3 encoder.

FIG. 12C illustrates a comparison of the performance of a rate 8/9 8-PSK SCTCM encoder with, respectively, a rate 3/3 and a rate 6/6 inner encoder.

FIG. 12D illustrates a comparison of the performance of a rate 4/5 QPSK SCTCM encoder with, respectively, a rate 2/2 and a rate 4/4 inner encoder.

FIG. 13A illustrates a comparison of the performance of a rate 2/3 SCTCM encoder with, respectively, a JPL “best distance” rate 5/6, a rate 3/3, a rate 6/6, and a JPL “best d2” rate 5/6 inner encoder.

FIG. 13B illustrates a comparison of the performance of a rate 5/6 SCTCM encoder with, respectively, a rate 3/3 and a rate 3/3 (“best d2”) inner encoder.

FIG. 13C illustrates a comparison of the performance of a rate 5/6 8-PSK SCTCM encoder with, respectively, a rate 3/3 and a rate 6/6 inner encoder.

FIG. 13D illustrates a comparison of the performance of a rate 8/9 8-PSK SCTCM encoder with, respectively, a rate 3/3 and a rate 6/6 inner encoder.

FIG. 14 is a block diagram of a decoder configured for use with the encoder of the subject invention.

FIG. 15 is an example of a trellis diagram.

FIG. 16 is an embodiment of a decoding process employed by a SISO in the decoder of FIG. 14.

FIG. 17 is an embodiment of an overall decoding process employed by the decoder of FIG. 14.

### DETAILED DESCRIPTION OF THE PREFERRED EMBODIMENTS

A. Example Environments

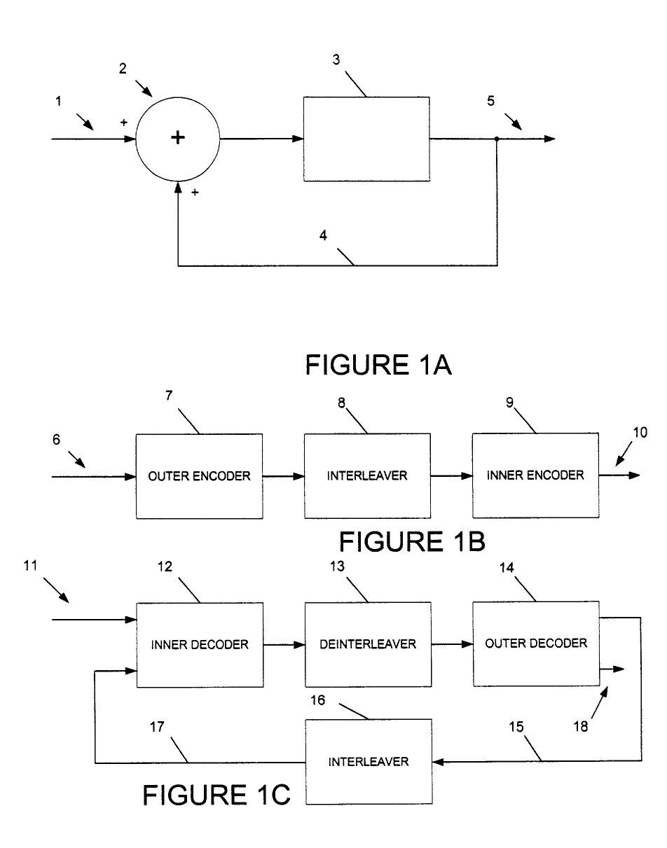

In a SCCC encoder, illustrated in FIG. 1B, an outer encoder 7 is coupled in series with an interleaver 8, which in turn is coupled to an inner encoder 9. Typically, each of the outer and inner encoders 7 and 9 are convolutional encoders. Input bits are input to outer encoder 7 over signal line 6. Encoded bits output from the outer encoder 7 are interleaved by interleaver 8. The interleaved bits are input to inner encoder 9. Inner encoder 9 encodes the interleaved bits and outputs the encoded bits on signal line 10.

A SCCC decoder, illustrated in FIG. 1C, is typically iterative. An inner decoder 12 is coupled in series with de-interleaver 13 which in turn is coupled in series with outer decoder 14. A feedback loop is provided between an output of outer decoder 14 and an input of inner decoder 12. Included in the feedback loop is interleaver 16. After transmission over a channel, incoming bits are input to inner decoder 12 over signal line 11. A priori information is provided to the inner decoder 12 from interleaver 16 over signal line 17. After a prescribed number of iterations, the decoded bits are output by the outer decoder on signal line 18.

Serial concatenated trellis coded modulation (SCTCM) is a technology related to SCCC. An encoder for SCTCM is similar to that for SCCC, except that, in the SCTCM encoder, a bit to symbol mapper is coupled in series with inner encoder 9, and the output of the encoder thus consists of encoded channel symbols rather than bits. Similarly, a decoder for SCTCM is similar to that for SCCC except that, in the SCTCM decoder, encoded symbols after transmission over a channel are input to the inner decoder 12 rather than encoded bits.

B. Embodiments of Invention

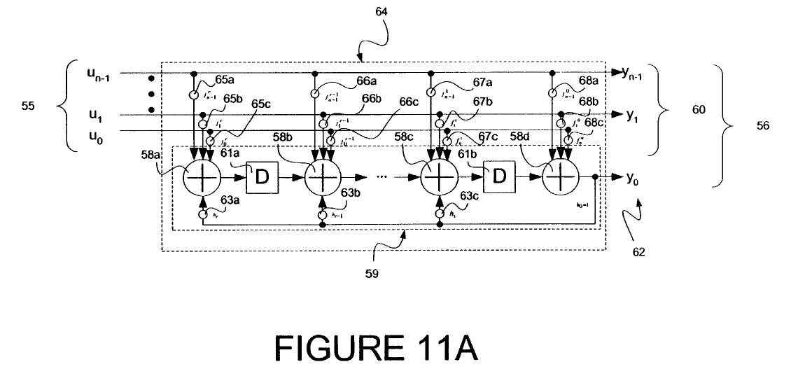

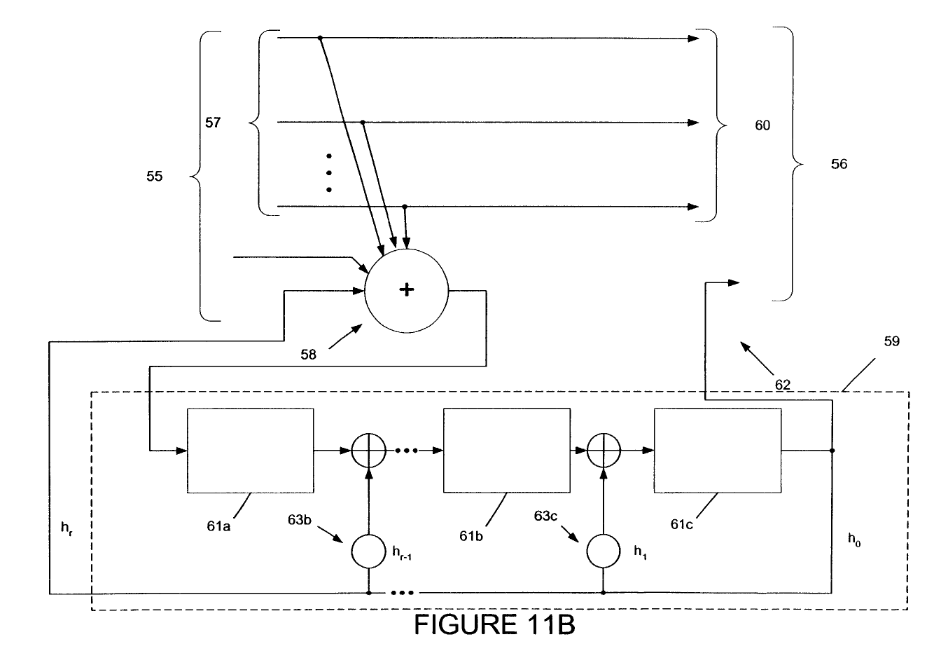

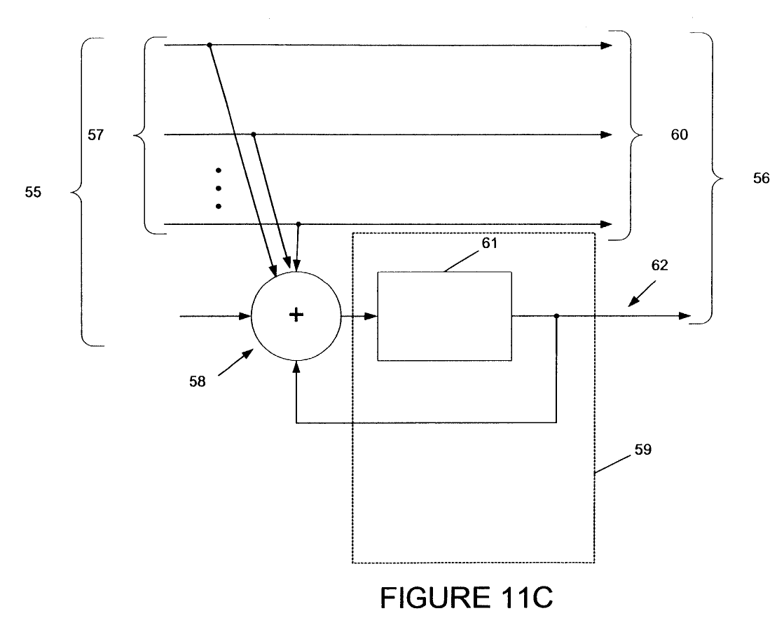

A first embodiment of a rate n/n encoder in accordance with the subject invention is illustrated in FIG. 11A. As illustrated, the encoder has n inputs, u₀, u₁, . . . , uₙ₋₁, where n is an integer greater than 1. These n inputs are identified in the figure with numeral 55. In addition, the encoder has n outputs, y₀, y₁, . . . , yₙ₋₁, again where n is an integer greater than 1. These n outputs are identified in the figure with numeral 56. Of these n outputs, (n−1) are each derived from separate ones of the inputs. These (n−1) outputs are identified in the figure with numeral 60. In the figure, these particular outputs are identified as y₁, . . . , Yₙ₋₁, i.e., last (n−1) members of the sequence y₀, y₁, . . . , yₙ₋₁, but it should be appreciated that this terminology in not intended to be limiting, and that embodiments are possible where any (n−1) members of the sequence y₀, y₁, . . . , yₙ₋₁ form the (n−1) outputs identified with numeral 60.

The nth output, identified in the figure with numeral 62, is derived from logic 64, which may be implemented as hardware, software, or a combination of hardware and software. In the figure, the nth output is referred to as y₀, but again it should be appreciated that this terminology is not intended to be limiting, and that embodiments are possible where any member of the sequence y₀, y₁, . . . , yₙ₋₁ forms the output identified with numeral 62.

The logic 64 comprises one or more arithmetic elements, identified in the figure with numerals 58a, 58b, 58c, and 58d, and one or more storage elements, identified in the figure with numerals 61a and 61b. Although the one or more arithmetic elements and the one or more storage elements are shown in the figure as being coupled in an alternating series arrangement, it should be appreciated that this depiction is not intended to be limiting, and that embodiments are possible where these elements are coupled in series, in parallel, or a combination of series and parallel relationships, and also where the one or more arithmetic elements and the one or more storage elements are in other than alternating series or parallel relationships.

The logic 64 forms one or more feedback loops, identified in the figure with numeral 59, from the nth output 62 (or some other location within or signal provided by the logic 64) to one or more of the arithmetic or storage elements. These one or more feedback loops may be characterized by a prime polynomial, which can be expressed as follows: h₀+(h₁×X)+ . . . +(hᵣ₋₁×X^{r-1})+(hᵣ×X^{r}), where r is an integer of 1 or more, in which h₀=1 and hᵢ, where 0<i≦r, reflect the state of modules 63a, 63b, 63b. In one implementation, each of the modules 63a, 63b, and 63c can be either in closed or open states, and can be implemented either in hard-wired form, i.e., where the state is fixed, or soft-wired form, i.e., where the state can be varied. In one implementation example, the modules 63a, 63b, and 63c can simply be the presence or absence of a wire or signal line, with the open state reflecting the lack of a signal line or wire, and the closed state reflecting the presence of a signal line or wire. Typically, the state hᵢ of a module may be either 0 or 1, with 1 indicating the closed state, and 0 indicating the open state, but it should be appreciated that embodiments are possible where these assignments are reversed, where the states may be expressed in the form of values other than 0 or 1, or where the modules may be in more than 2 states. In one example, in the case in which r=3, the states of modules 63a, 63b, and 63c are such that h₁=1, h₂=0, and h₃=1, and the polynomial characterizing the feedback loop can be expressed as X³+X+1.

In addition to inputs from the one or more feedback loops 59, each of the arithmetic units 58a, 58b, 58c. 58d may also receive as inputs one or more outputs of storage elements 61a, 61b, as well as zero or more of the n inputs to the encoder, u₀, u₁, . . . , uₙ₋₁. With reference to FIG. 11A, the inputs to arithmetic unit 58a (other than the input from module 63a) may be expressed as follows: (f₀^{r}×u₀)+(f₁^{r}×u₁)+ . . . +(fₙ₋₁^{r}×uₙ₋₁), where fᵢ^{r}, 0≦i≦(n−1), reflect the state of modules 65a, 65b, 65c. As with modules 63a, 63b, 63c, the modules 65a, 65b, 65c can be in either open or closed states, can be implemented in either hard-wired or soft-wired form, and can simply be the presence or absence of a wire or signal line. Moreover, as with modules 63a, 63b, 63c, the state of the modules 65a, 65b, 65c may typically be either 0 or 1, with 0 indicating the open state, and 1 indicating the closed state, but it should be appreciated that embodiments are possible where these assignments are reversed, where the states are expressed in the form of values other than 0 and 1, or where the modules may take on more than 2 states.

Similarly, with reference to FIG. 11A, the inputs to arithmetic unit 58b (other than the inputs from storage element 61a and module 63b) may be expressed as follows: (f₀^{r-1}×u₀)+(f₁^{r-1}×u₁)+ . . . +(fₙ₋₁^{r-1}×uₙ₋₁), where fᵢ^{r-1}, 0≦i≦(n−1), reflect the state of modules 66a, 66b, 66c. As with the modules 65a, 65b, 65c, the modules 66a, 66b, 66c can be in either open or closed states, can be implemented in either hard-wired or soft-wired form, and can simply be the presence or absence of a wire or signal line. Moreover, as with the modules 65a, 65b, 65c, the state of the modules 66a, 66b, 66c may typically be either 0 or 1, with 0 indicating the open state, and 1 indicating the closed state, but it should be appreciated that embodiments are possible where these assignments are reversed, where the states are expressed in the form of values other than 0 and 1, or where the modules may take on more than 2 states.

Also, with reference to FIG. 11A, the inputs to arithmetic unit 58c (other than an input from a storage element (not shown) and the input from module 63c) maybe expressed as follows: (f₀¹×u₀)+(f₁¹×u₁)+ . . . +(fₙ₋₁¹×uₙ₋₁), where fᵢ¹, 0≦i≦(n−1), reflect the state of modules 67a, 67b, 67c. As with the modules 66a, 66b, 66c, the modules 67a, 67b, 67c can be in either open or closed states, can be implemented in either hard-wired or soft-wired form, and can simply be the presence or absence of a wire or signal line. Moreover, as with modules 66a, 66b, 66c, the state of the modules 67a, 67b, 67c may typically be expressed as either 0 or 1, with 0 indicating the open state, and 1 indicating the closed state, but it should be appreciated than embodiments are possible where these assignments are reversed, where the states are expressed in the form of values other than 0 or 1, or where the modules may take on more than 2 states.

Again with reference to FIG. 11A, the inputs to arithmetic unit 58d (other than the input from storage element 61b) may be expressed as follows: (f₀⁰×u₀)+(f₁⁰×u₁)+ . . . +(fₙ₋₁⁰×uₙ₋₁), where fᵢ⁰, 0≦i≦(n−1), reflect the state of modules 68a, 68b, 68c. As with modules 67a, 67b, 67c, the modules 68a, 68b, 68c may be in either open or closed states, can be implemented in either hard-wired or soft-wired form, and can simply be the presence or absence of a wire or signal line. Moreover, as with modules 67a, 67b, 67c, the state of the modules 68a, 68b, 68c may typically be either 0 or 1, with 1 indicating the closed state, and 0 indicating the open state, but it should be appreciated that embodiments are possible where these assignments are reversed, where the states are expressed in terms of values other than 0 or 1, or where the modules may take on more than 2 states.

The arithmetic elements 58a, 58b, 58c, 58d in this embodiment may be any element that logically or arithmetically combines the inputs thereof, but, in one implementation, where the elements receive single bit operands and 2's complement arithmetic is utilized, the elements 58a, 58b, 58c, 58d may be in the form of adders, exclusive OR elements, or subtractors, since, with single bit operands and 2's complement arithmetic, these forms are all equivalent.

A second embodiment of a rate n/n encoder in accordance with the subject invention is illustrated in FIG. 11B in which, compared to FIG. 11A, like elements are referred to with like identifying numerals. As illustrated, the encoder comprises n inputs 55, wherein n is an integer greater than 1, n outputs 60, and logic including an adder 58 and one or more storage elements 61a, 61b, and 61c. One or more feedback loops 59 may be formed between the nth output 62 of the encoder (or from some other location within or signal provided by the logic) to the adder 58, and/or one or more storage elements 61a, 61b, 61c, wherein the one or more feedback loops may be characterized by a prime polynomial. (n−1) of the encoder inputs, identified in the figure with numeral 57, are systematic inputs. That means they are passed through the encoder to form (n−1) of the encoder outputs, identified with numeral 60. The nth encoder output, identified with numeral 62, may be derived from the logic. One or more of the n inputs 55 of the encoder may be input to the adder 58. Other inputs to adder 58 are also possible. In addition, the encoder output 62 (or one or more other signals provided by the logic) may also be input to the adder 58. The nth encoder output 62 may be derived from an output of one of the storage elements 61a, 61b, 61c, or from the output of the adder 58.

The storage elements 61a, 61b, 61c may be coupled in a series relationship. In addition, adders (shown but not identified with numerals in FIG. 11B) may be placed between all or selected ones of the storage elements 61a, 61b, 61c, depending on the state of the modules 63b, 63c. More specifically, if a module 63b, 63c is in an open state, such an adder need not be included between the two corresponding storage elements.

The adder 58 may logically add the inputs thereof, or equivalently, logically subtract one or more of the inputs, since logical addition and subtraction have the same result with 2's complement arithmetic and single bit operands. For purposes of this invention, the term “adder” is meant to encompass both modes of operation.

The polynomial characterizing the one or more feedback loops in FIG. 11B can be expressed as follows: h₀+(h₁×X)+ . . . +(hᵣ₋₁×X^{r-1})+(hᵣ×X^{r}), in which h₀=hᵣ=1 and h₁, where 0<i<r, expresses the state of modules 63b, 63c. Typically, the modules 63b, 63c can be in open or closed states, and can be implemented in hard- or soft-wired form. In one implementation, these modules are simply implemented as the presence or absence of signal lines or wires. Also, the open state may typically be represented by a 0, and the closed state may typically be represented by a 1, but it should be appreciated that embodiments are possible where these assignments are reversed, where values other than 0 and 1 are used to represent state assignments, or where the modules 63b, 63c may take on more than one of two states. In one example, in the case in which r=3, and module 63c i is such that h₁=1, and module 63b is such that h₂=0, the polynomial characterizing the feedback loop can be expressed as X³+X+1.

One implementation of a rate n/n encoder configured in accordance with the subject invention is illustrated in FIG. 11C in which, compared to FIGS. 11A-11B, like elements are referenced with like identifying numerals.

In this implementation, the logic includes adder 58 and storage element 61. In addition, a feedback loop 59 may be provided between the output 62 of the storage element 61 and an input to the adder 58, or from the output of adder 58 to the input of storage element 61. The polynomial which characterizes this feedback loop is (1+X), which is a prime polynomial. The constraint length, which equals the number of storage elements plus 1, is equal to 2. The nth output of the encoder, identified with numeral 62, may be the output of storage element 61 or adder 58.

There are several aspects of this encoder which make it well-suited for functioning as the inner encoder in a SCTCM or SCCC encoder.

The first is that a single bit error at the input of the encoder will typically magnify itself, and result in many bit errors in the output of the encoder. This can be seen most directly from FIG. 11C. Assume all input bits should be 0 and that, at a time t, one of the input bits is perturbed by noise and is a 1. The output 62 of the storage element will remain a 1 until another one of the input bits is perturbed by noise and is switched to a 1. This is a desirable attribute for an inner encoder in a SCTCM or SCCC encoder because it makes it more likely that the erroneous bit would be detected by the decoder.

The second is that, because its rate is 1, it allows more redundancy to be shifted to the outer encoder. This is a desirable attribute because it results in a lowering of the bit error rate (BER) in the floor portion of the BER vs. E_{b}/N₀ curve for the SCTCM or SCCC encoder. This is explained more fully in the following paragraphs.

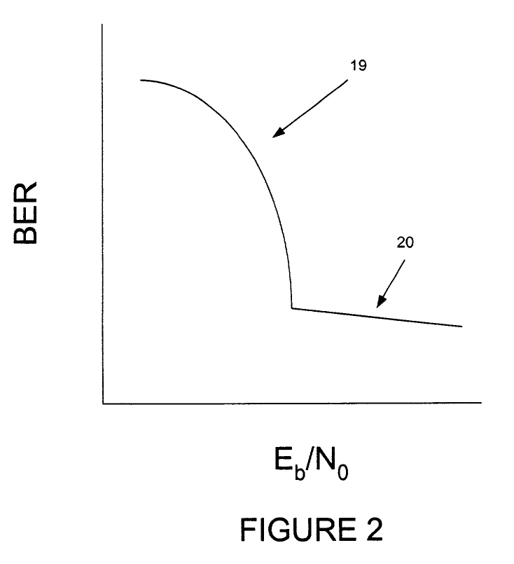

An example of an E_{b}/N₀ curve for a SCTCM encoder is illustrated in FIG. 2. The curve has a waterfall region, identified with numeral 19, and a floor region, identified with numeral 20. Typically, the SCTCM encoder is operated at a point on the floor region 20.

The BER of the floor region is related to

$${N}^{- ⌊ \frac{( {d}_{free} - 1 )}{2} ⌋} ,$$

where N is the interleaver length, and d_{free} is the free distance of the outer encoder. Therefore, by shifting redundancy to the outer encoder, which has the effect of increasing d_{free}, the BER for the floor region can be shifted lower. For example, consider a SCTCM encoder with a desired rate of 2/3. For a rate 5/6 inner encoder, a rate 4/5 outer encoder is required. At the rate, a BER of 10⁻⁸ to 10⁻⁹ is possible. However, for a rate 1 inner encoder, a rate 2/3 outer encoder can be used. That results in a BER of 10⁻¹¹ to 10⁻¹², which is a significant difference.

The third is that the related decoder is less complex and simpler to implement than the rate (2b+1)/(2b+2) decoder associated with the encoder disclosed in Divsalar 1, 2, and 3.

The fourth is that it generally provides superior performance to the rate 1 encoders disclosed in Divsalar 4.

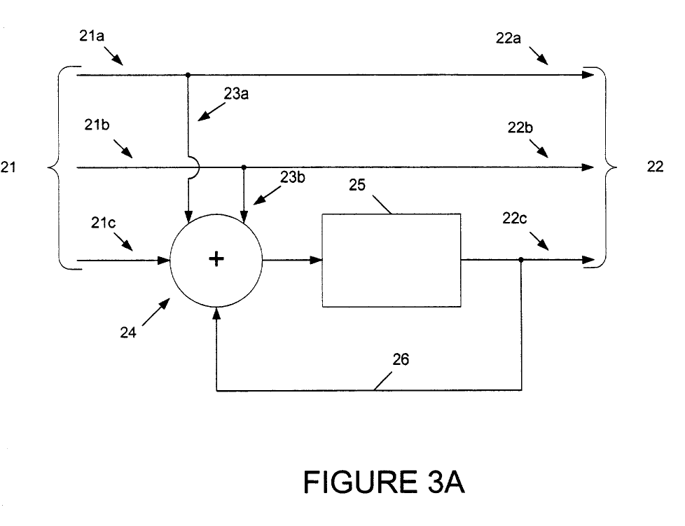

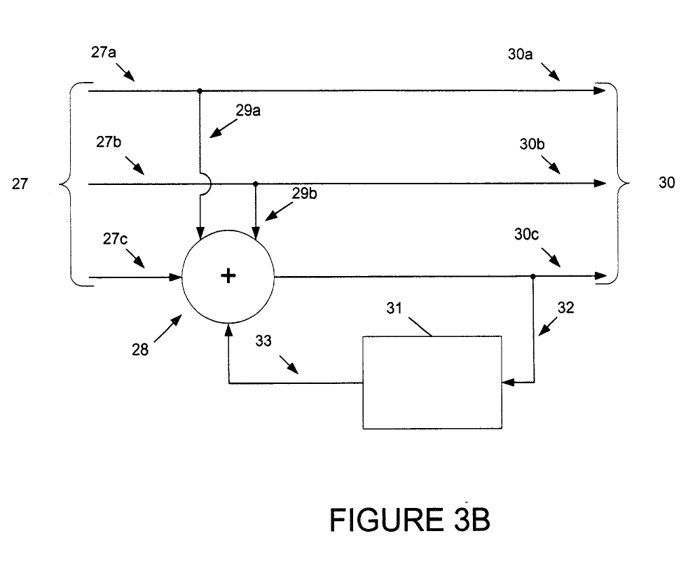

A first embodiment of a rate 3/3 encoder in accordance with the subject invention is illustrated in FIG. 3A. As shown, this encoder comprises 3 inputs, identified with numeral 21, and 3 outputs, identified with numeral 22. Each of the 3 inputs 21a, 21b, 21c is input to adder 24. In addition, two of the inputs, 21a and 21b, are systematic inputs and are passed directly through the encoder to form outputs 22a and 22b. The output of the adder 24 is coupled to storage device 25. The output of storage device 25 forms output 22c. In addition, the output of storage device 25 forms an input to adder 24.

A second embodiment of a rate 3/3 encoder in accordance with the subject invention is illustrated in FIG. 3B. As shown, this encoder comprises 3 inputs, identified with numeral 27, and 3 outputs, identified with numeral 30. Each of the 3 inputs 27a, 27b, 27c is input to adder 28. In addition, two of the inputs, 27a and 27b, are systematic inputs and are passed directly through the encoder to form outputs 30a and 30b. The output of the adder 28 forms output 30c. In addition, the output of adder 28 is forms the input to storage device 31. The output of storage device 31 forms an input to adder 28. Compared to the embodiment of FIG. 3B, the embodiment of FIG. 3A is preferred because it will have slightly better distance properties, although both are advantageous in relation to the prior art.

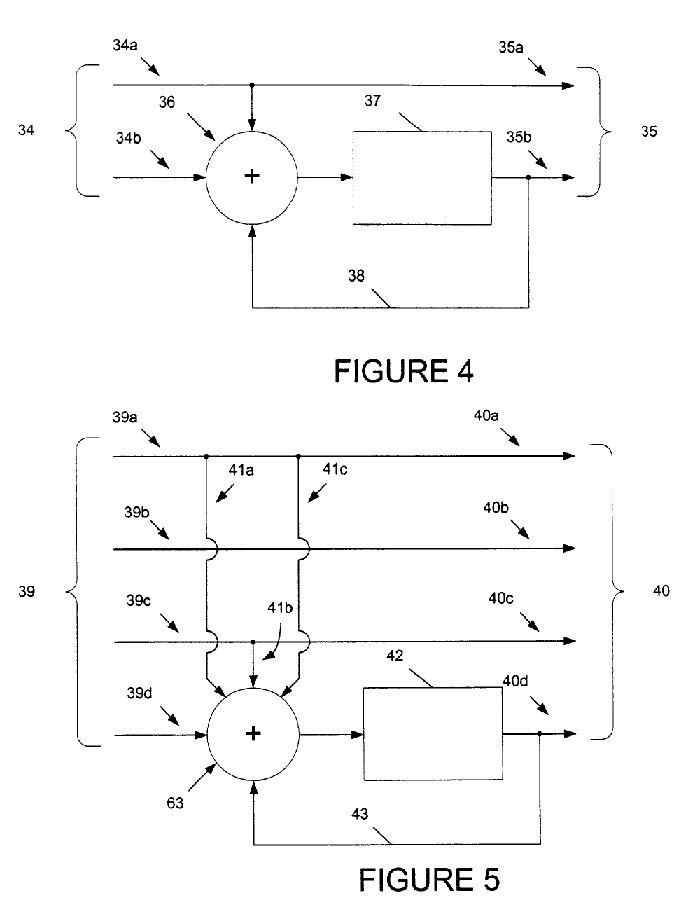

An embodiment of a rate 2/2 encoder in accordance with the subject invention is illustrated in FIG. 4. As shown, the encoder has 2 inputs, identified with numeral 34, and 2 outputs, identified with numeral 35. Each of the two inputs 34a, 34b is input to adder 36. In addition, one of the inputs, 34a, is a systematic input and is passed directly through the encoder to form output 35a. The output of adder 36 forms the input to storage device 37. The output of storage device 37 forms output 35b. In addition, the output of storage device 37 forms an input to adder 36.

An embodiment of a rate 4/4 encoder in accordance with the subject invention is illustrated in FIG. 5. As shown, this encoder comprises 4 inputs, identified with numeral 39, and 4 outputs, identified with numeral 40. Each of the 4 inputs 39a, 39b, 39c is input to adder 63. In addition, three of the inputs, 39a, 39b, 39c are systematic inputs and are passed directly through the encoder to form outputs 40a, 40b, 40c. The output of the adder 63 is coupled to storage element 42. The output of storage element 42 forms output 40d. In addition, the output of storage element 42 forms an input to adder 63.

Alternative versions of the embodiments of FIGS. 4 and 5 are also possible in which the output of the adder forms an output of the encoder. These variants are logical extensions of the embodiment illustrated in FIG. 3B, and need not be discussed further.

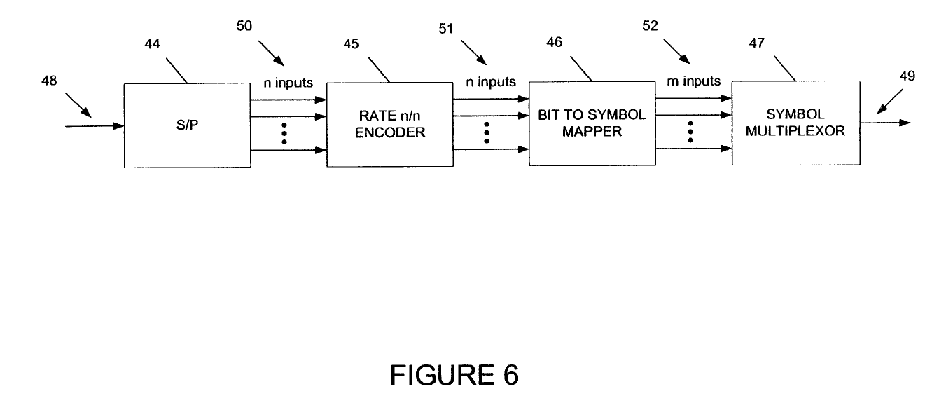

The rate n/n encoder of the subject invention may comprise or form part of an inner encoder of a SCCC or SCTCM encoder. FIG. 6 illustrates an inner encoder for a SCTCM encoder which incorporates the rate n/n encoder of the subject invention. As illustrated, the inner encoder comprises a serial to parallel (S/P) converter 44, a rate n/n encoder 45 configured in accordance with the subject invention, a bit to symbol mapper 46, and, optionally, a symbol multiplexor 47. Incoming bits (such as from interleaver 8 in FIG. 1B) 48 are serially input to S/P converter 44. S/P converter 44 converts the serial stream of input bits to successive parallel renditions of n bits each. Each n bit rendition 50 is input to a rate n/n encoder 45 configured in accordance with the subject invention. The output of the rate n/n encoder comprises successive parallel renditions of n bits each. Each n bit rendition 51 is input to bit to symbol mapper 46. Bit to symbol mapper 46 converts each rendition 51 of n bits to a D-dimensional channel symbol, where D is an integer equal to 1 or more. In the case in which n=D=1, the symbol multiplexor 47 is unnecessary. In the cases in which n D or n=D>1, the symbol multiplexor 47 serialize the D components of a D-dimensional symbol and outputs the same on signal line 49. In one implementation, the multiplexor serializes the D components 2 at a time to represent the I and Q components of a quadrature output.

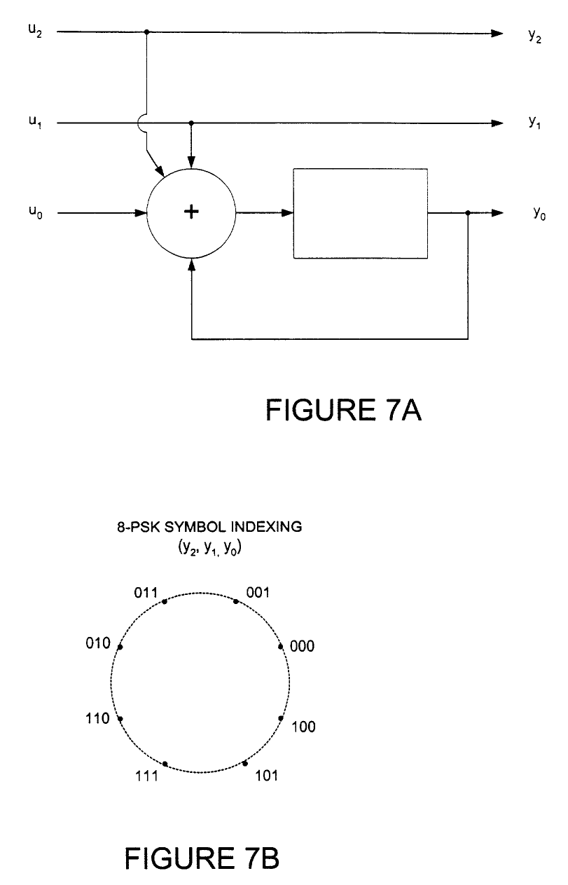

FIGS. 7-9 illustrate various embodiments of a combination of a rate n/n encoder in accordance with the subject invention and a bit to symbol mapper. FIG. 7A illustrates an embodiment of a rate 3/3 encoder in accordance with the subject invention in which a 3-tuple of input bits is represented by (u₂, u₁, u₀), and a 3-tuple of output bits by (y₂, y₁, y₀). FIG. 7B illustrates the functioning of the bit to symbol mapper which, in this particular example, maps each 3-tuple (y₂, y₁, y₀) output from the encoder into an 8-PSK symbol. The particular mapping which is used can be represented by the following table:

| 3-tuple (y₂, y₁, y₀) | 8-PSK symbol |
|---|---|
| (0, 0, 0) | π/16 |
| (0, 0, 1) | 3π/16 |
| (0, 1, 1) | 5π/16 |
| (0, 1, 0) | 7π/16 |
| (1, 1, 0) | 9π/16 |
| (1, 1, 1) | 11π/16 |
| (1, 0, 1) | 13π/16 |
| (1, 0, 0) | 15π/16 |

As can be seen, in this particular example, a Gray mapping is employed, in which adjacent symbols correspond to 3-tuples which differ by no more than a single bit.

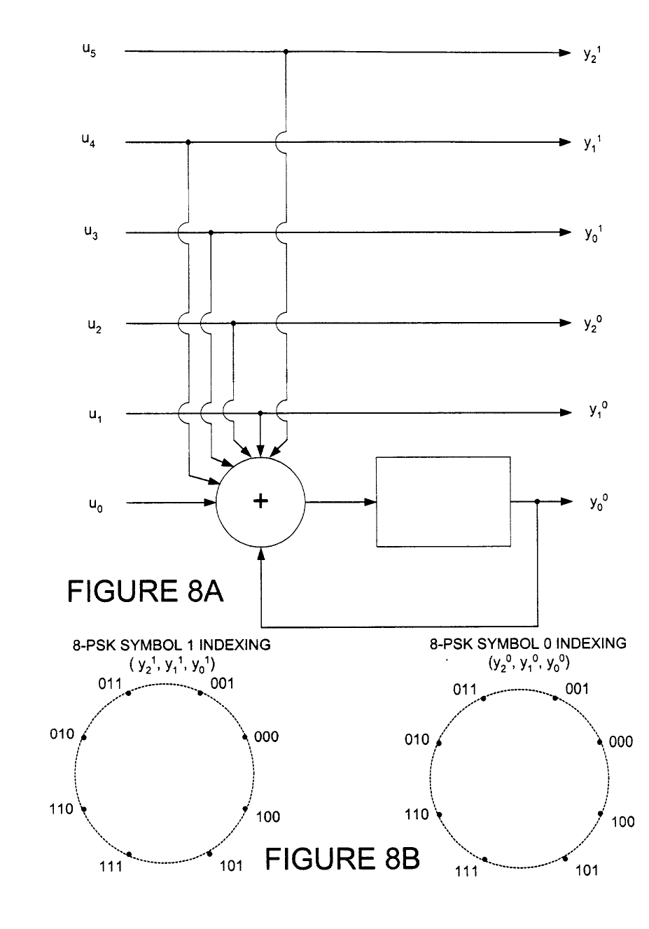

FIG. 8A illustrates an embodiment of a rate 6/6 encoder in accordance with the subject invention in which a 6-tuple of input bits is represented by (u₅, u₄, u₃, u₂, u₁, u₀). The encoder is configured to be used in combination with a 4-dimensional bit to symbol mapper is which the 6 output bits form two 3-tuples, represented respectively as (y₂¹, y₁¹, y₀¹) and as (y₂⁰, y₁⁰, y₀⁰), and each such 3-tuple is mapped into an 8-PSK symbol. FIG. 8B illustrates the functioning of this bit to symbol mapper. The particular mapping which is used can be represented by the following table:

| 3-tuple (y₂¹, y₁¹, y₀¹), i = 0, 1 | 8-PSK symbol |
|---|---|
| (0, 0, 0) | π/16 |
| (0, 0, 1) | 3π/16 |
| (0, 1, 1) | 5π/16 |
| (0, 1, 0) | 7π/16 |
| (1, 1, 0) | 9π/16 |
| (1, 1, 1) | 11π/16 |
| (1, 0, 1) | 13π/16 |
| (1, 0, 0) | 15π/16 |

As can be seen, in this particular example, a Gray mapping is employed, in which adjacent symbols correspond to 3-tuples which differ by no more than a single bit. An alternate Gray mapping is also possible with 8-PSK since, as is known, there are two unique Gray maps for 8-PSK.

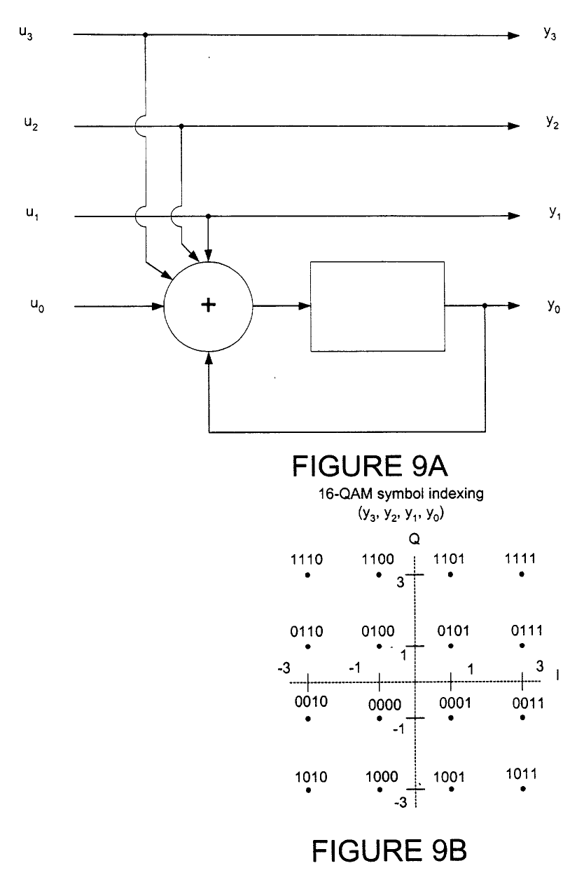

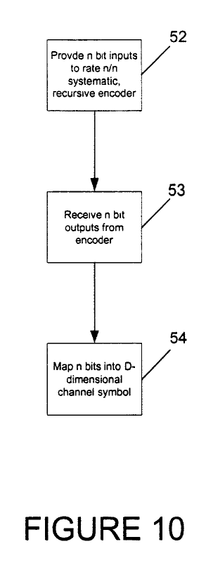

FIG. 9A illustrates an embodiment of a rate 4/4 encoder in accordance with the subject invention in which a 4-tuple of input bits is represented by (u₃, u₂, u₁, u₀). The encoder is configured to be used in combination with a bit to symbol mapper is which a 4-tuple of output bits, represented as (y₃, y₂, y₁, y₀), is mapped into a 16-QAM symbol. FIG. 9B illustrates the functioning of this bit to symbol mapper. The particular mapping which is used can be represented by the following table:

| | |
|---|---|
| 4-tuple (y₃, y₂, y₁, y₀) | 16-QAM symbol (I, Q) |

| | |
|---|---|
| (1, 1, 1, 0) | (−3, +3) |
| (1, 1, 0, 0) | (−1, +3) |
| (1, 1, 0, 1) | (+1, +1) |
| (1, 1, 1, 1) | (+3, +3) |
| (0, 1, 1, 1) | (+3, +1) |
| (0, 1, 0, 1) | (+1, +1) |
| (0, 1, 0, 0) | (−1, +1) |
| (0, 1, 1, 0) | (−3, +1) |
| (0, 0, 1, 0) | (−3, −1) |
| (0, 0, 0, 0) | (−1, −1) |
| (0, 0, 0, 1) | (+1, −1) |
| (0, 0, 1, 1) | (+3, −1) |
| (1, 0, 1, 1) | (+3, −3) |
| (1, 0, 0, 1) | (+1, −3) |
| (1, 0, 0, 0) | (−1, −3) |
| (1, 0, 1, 0) | (−3, −3) |

As can be seen, in this particular example, a Gray mapping is employed, in which adjacent symbols (in a horizontal or vertical sense) correspond to 4-tuples which differ by no more than a single bit.

Additional embodiments are possible in which any combination of phase, amplitude, and frequency modulation may be employed for the mapping process. For example, a rate 2/2 encoder in combination with a QPSK mapper, a rate 4/4 encoder in combination with a four-dimensional QPSK mapper, or a rate 6/6 encoder in combination with a six-dimensional QPSK mapper are all possible.

FIG. 11 is a flowchart illustrating an embodiment of a method of operation in accordance with the subject invention. In step 52, an n-tuple of bits is input to a rate n/n encoder configured in accordance with the subject invention, where n is an integer greater than 1. In step 53, an n-tuple of bits is received as an output from the encoder. In step 54, the n-tuple of output bits is mapped into a D-dimensional channel symbol, where D is an integer greater than or equal to 1. In one implementation, a Gray mapping is employed in which the tuple of bits corresponding to adjacent symbols differ by no more than 1 bit.

Several applications of the invention will now be described. In one application, a rate n/n encoder in accordance with the invention is combined with a bit to symbol mapper. The combination may form the inner encoder of a SCTCM encoder.

In another application, a rate n/n encoder in accordance with the invention forms the inner encoder of a SCCC encoder.

The foregoing SCTCM or SCCC encoders may comprise part of a transmitter which in turn may form part of a wireless or satellite transceiver. It may also be in a wireline transceiver (e.g., cable modem). The transceiver in turn may form part of a wireless device, including a mobile wireless device such as a handset or a wireless or satellite link in a vehicle, truck, or automobile, or an immobile device such as a set-top box coupled to a visual display such as a television or a computer monitor.

In one application, a transmitter incorporating a SCCC or SCTCM encoder (in which the inner encoder is an encoder of the subject invention) is used in conjunction with one or more receivers each incorporating a decoder corresponding to the SCCC or SCTCM encoder. The transmitter and receivers are coupled by a wireless interface. The transmitter broadcasts encoded information over the wireless interface to the one or more receivers. The receivers decode the information and correct for errors introduced through transmission over the wireless interface.

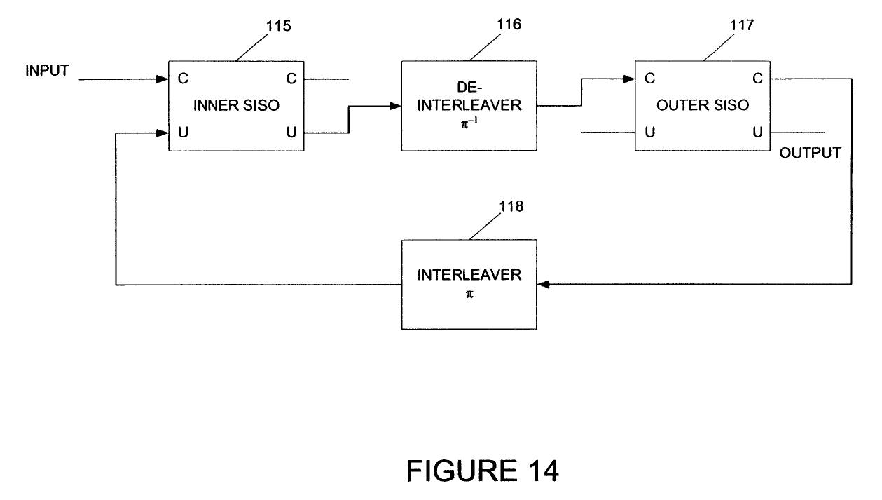

A block diagram of the decoder is illustrated in FIG. 14. As illustrated, two instances of a four port device known as a soft input soft output (SISO) module are employed in the system. The first such module is inner SISO 115, and the second such module is outer SISO 117.

Each such module has two inputs, a coded (C) bit input, and an uncoded (U) bit input, and two outputs, a coded (C) bit output, and an uncoded (U) bit output. A priori information is provided to either or both inputs of the SISO. Responsive thereto, the SISO computes extrinsic a posteriori information. For the inner SISO, this extrinsic information is log-likelihood ratios (LLRs) for each of the source bits. For the outer SISO, this extrinsic information is LLRs for each of the coded symbols. After a prescribed number of iterations, the outer SISO provides a posteriori information for each of the source bits. The LLRs for the coded symbols are output on the C output of the SISO module, and those for the uncoded source bits are output on the U output of the SISO module.

With reference to FIG. 14, information received over the wireless interface, comprising encoded symbols output by a SCCC or SCTCM encoder (in which the inner encoder is an encoder of the subject invention) and perturbed by noise through transmission over the wireless interface, are input to the coded (C) input of inner SISO 115. A priori information is provided to the U input of inner SISO 115 by interleaver 118. This information originates from the C output of SISO 117.

The extrinsic U output of the inner SISO module 115, after passage through de-interleaver 116, forms a priori information which becomes the sole input to outer SISO 117. This a priori information is input to the C input of outer SISO 117, the U input of which is not used.

The inner SISO 115 corresponds to, and in some sense is intended to decode, inner encoder 9 (FIG. 1B), while the outer SISO 117 corresponds to, and in some sense is intended to decode, outer encoder 7 (FIG. 1B).

The decoder of FIG. 14 is iterative. After a predetermined number of iterations, the LLRs provided at the U output of the outer SISO module 117 are used to form the estimates of the unencoded source bits through comparison with a predetermined threshold. If the LLR exceeds the threshold, the corresponding estimate is set to a logical one; otherwise, the estimate is set to a logical zero. Note that, prior to the completion of the predetermined number of iterations, the U output of the outer SISO 117 is unused.

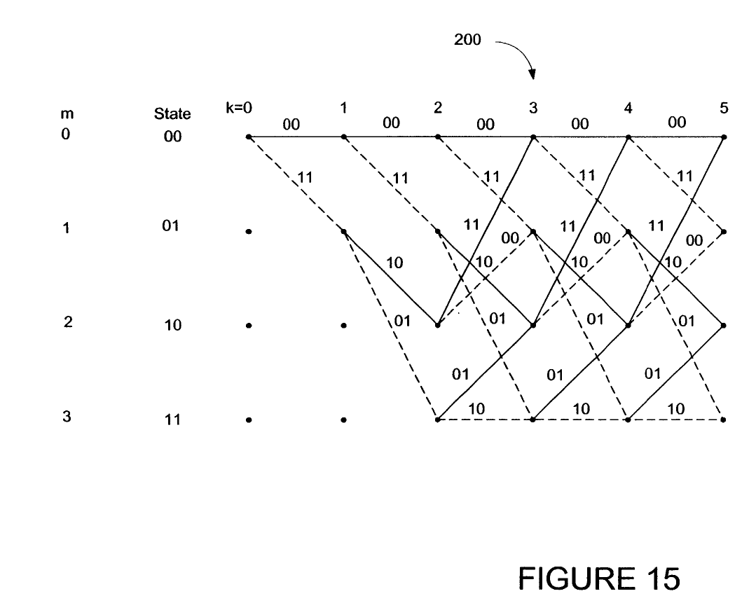

The process employed by each of the SISOs can be further explained in relation to a trellis diagram, an example of which is illustrated in FIG. 15. The horizontal axis of the trellis represents time, while the vertical axis represents the state of the corresponding convolutional encoder. The index k is used to refer to time, while the index m is used to refer to the state of the corresponding convolutional encoder. The branches represent permissible state transitions. A solid branch represents a state transition that occurs upon the receipt of an unencoded source bit which is a logical zero, while a dashed branch represents a state transition that occurs upon the receipt of an unencoded source bit which is a logical one. Each branch is labeled with the corresponding encoder output.

As observations, either intrinsic or extrinsic, are received, the SISO recursively calculates forward probabilities, that is, probabilities which, at time k, are computed based on the probabilities which are computed at time k−1. The forward probabilities are computed for each of the nodes m. In addition, the SISO recursively calculates reverse probabilities, that is, probabilities which, at time k, are computed based on the probabilities computed at time k+1.

A sliding window technique is employed in which a forward engine recursively calculates forward state probabilities for a portion of the trellis in a forward sliding window, and one or more backward engines recursively calculate backward state probabilities for portions of the trellis in one or more backward sliding windows. The backward recursion is performed by calculating probabilities at time k based on the probabilities which were computed at time k+1. The forward recursion is performed by calculating probabilities at time k based on the probabilities which were computed at time k−1. At the point in the trellis where these two processes overlap, transition probabilities can be computed. These transition probabilities are then used to compute LLRs.

The process continues as the forward sliding window is moved forward through the trellis, and the one or more backward sliding windows are moved backward through the trellis. Eventually, the process results in LLRs being computed for each of the times k represented by the trellis. LLRs for both the coded symbols and unencoded source bits are computed. These LLRs are refined as the iterations progress. When the prescribed number of iterations has been completed, the LLRs are used to estimate the unencoded source bits.

The process is a modified form of the algorithm described in “Optimal Decoding of Linear Codes for Minimizing Symbol Error Rate,” L. R. Bahl et al., IEEE Transactions on Information Theory, March 1974, pp. 27-30 (hereinafter referred to as “the Bahl reference”), with the specific modifications thereof being described in “Near Shannon Limit Error-Correcting Coding and Decoding: Turbo Codes,” C. Berrou et al., Proc. ICC '93 Geneva, Switzerland, May 1993, pp. 1064-1070 (hereinafter referred to as “the Berrou reference”). Both of these references are hereby fully incorporated by reference herein as though set forth in full.

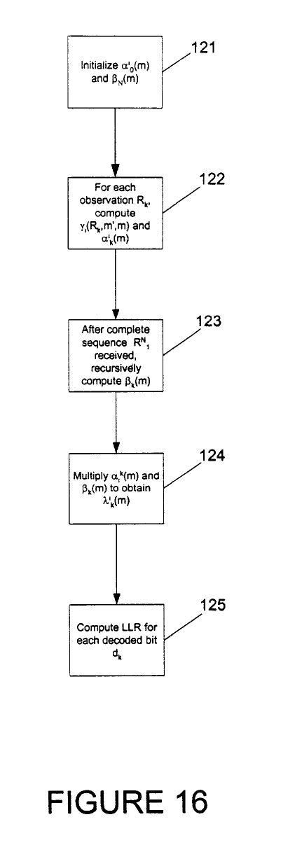

A flowchart of the process is illustrated in FIG. 16. Although this flowchart generally illustrates the process which is employed by both the inner and outer SISOs, there are slight differences in the procedure employed by the two SISOs, which will be highlighted in the following discussion. In this flowchart, the notation αⁱₖ(m), γᵢ(Rₖ,m′,m), and βₖ(m) are described in the Berrou reference.

In step 121, the boundary values αⁱ₀(m) and β_{N}(m) are initialized for all values of m.

In step 122, for each observation Rₖ, the probabilities α¹ₖ(m) and γᵢ(Rₖ,m′,m) are computed using equations (21) and (23) from the Berrou reference. Note that the “observation” Rₖ which is received differs between the two SISOs. For the inner SISO 115, each observation Rₖ comprises the channel symbols output from inner encoder 9, as perturbed by noise through passage through the channel, and also z₁ₖ, the a priori information originating from outer SISO 117, and passed through interleaver 118. For the outer SISO 117, each observation Rₖ comprises z₂ₖ, the a priori information originating from outer SISO 117, and passed through interleaver 118. Through these equations, the probabilities αⁱₖ(m) are computed recursively as a function of αⁱₖ₋₁(m).

In step 123, after the complete sequence R₁^{N} has been received, the probabilities βₖ(m) are computed using equation (22) from the Berrou reference. Through this equation, the probabilities βₖ(m) are computed recursively as a function of βₖ₊₁(m).

In step 124, the joint probabilities λ¹ₖ(m) are computed y multiplying αⁱₖ(m) and βₖ(m) as follows: λⁱₖ(m)=αⁱₖ(m)·βₖ(m).

In step 125, the a posteriori probability (APP) that an unencoded source bit, dₖ, is the value i, is computed, both for i=0 and for i=1, using the equation

$${APP}_{i} = {\sum }_{m} {λ}_{k}^{i} , i = 0 , 1.$$

Then, the log-likelihood ratio for the bit dₖ is computed using the following equation:

$$LLR ( {d}_{k} ) = \frac{{APP}_{i = 1}}{{APP}_{i = 0}} = \frac{{\sum }_{m} {λ}_{k}^{1} ( m )}{{\sum }_{m} {λ}_{k}^{0} ( m )} .$$

After a prescribed number of iterations, this value is then used to form the estimate of dₖ by comparing it to a predetermined threshold. Prior to then, these values, after passage through de-interleaver 118, form the a priori information which is provided to the C input of outer SISO 117.

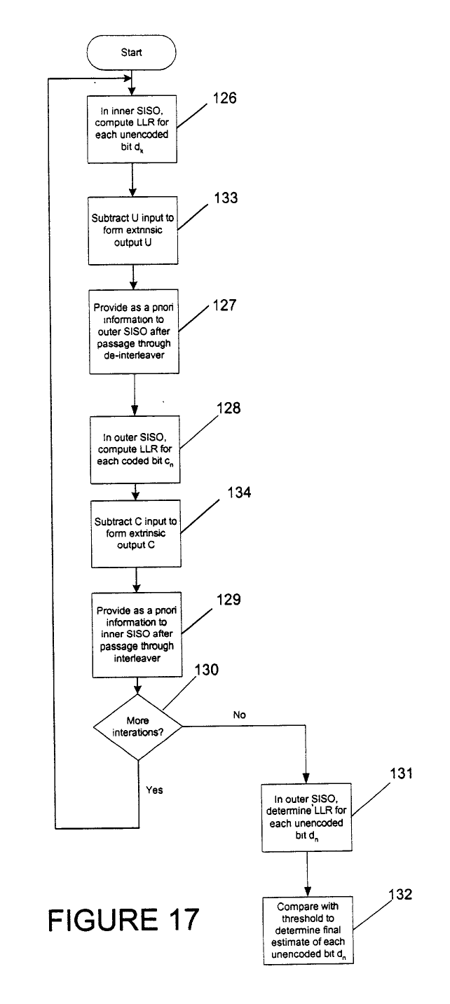

FIG. 17 illustrates the overall process employed by the system of FIG. 14. In step 126, within the inner SISO 115, after receipt of a frame of observations Rₖ, the LLRs for each of the unencoded source bits dₖ are computed.

In step 133, the a priori C input to the inner SISO 115 is subtracted from these LLRs to form extrinsic information output from the U output of inner SISO 115.

In step 127, after passage through de-interleaver 16, these values are provided as a priori information to the C input of outer SISO 117. Responsive thereto, in step 128, the outer SISO 117 computes the LLRs for each of the coded bits cₙ.

In step 134, the a priori information provided to the C input of outer SISO 117 is subtracted from these LLRs to provide extrinsic information.

In step 129, after passage through interleaver 118, these extrinsic values are provided as a priori information to the U input of inner SISO 115.

In decision block 130, it is determined whether additional iterations should be performed. If so, the process is repeated, beginning with step 126. If not, a jump is made to step 131. Instep 131, in the outer SISO 117, the LLR for each unencoded bit dₖ is determined, and then, in step 132, the LLRs are compared with a predetermined threshold to determine estimates of the unencoded bits dₖ.

The decoder may be any soft output iterative decoder configured to decode serial concatenated codes in which the outer code is a redundant convolutional code, and the inner coder is a rate n/n systematic recursive convolutional code of the subject invention. The decoder may employ, without limitation, the Viterbi algorithm, the soft output Viterbi algorithm (SOVA), a maximum a posteriori (MAP) algorithm, or the a posteriori probability (APP) algorithm.

### EXAMPLES

The performance of a SCTCM encoder utilizing as its inner encoder the combination of a rate n/n encoder in accordance with the invention and a bit to symbol mapper was simulated over a variety of conditions. The parameters varied include the overall rate of the SCTCM encoder and the value of n for the rate n/n encoder. In addition, the performance of a SCTCM encoder utilizing as its inner encoder the combination of a rate n/n or rate (2b+1)/(2b+2) encoder configured as described in Divsalar 1, 2, 3, or 4 (the collective teachings of which will hereinafter be referred to as “Divsalar”) with a bit to symbol mapper was also simulated. These results allow the performance of different rate n/n encoders to be compared to one another; they also allow the performance of the rate n/n encoders of the subject invention to be compared to that of the rate n/n and the rate (2b+1)/(2b+2) encoders described in Divsalar.

The results are all in the form of BER vs. E_{b}/N₀ plots. The waterfall region of these plots was calculated using Monte Carlo simulation; the floor region was estimated from a Union (upper) bound derivation.

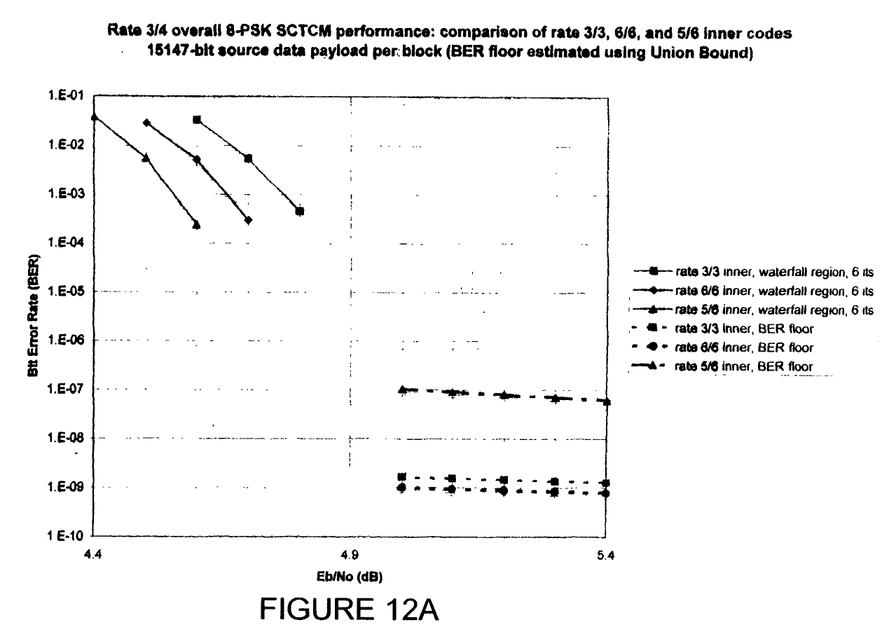

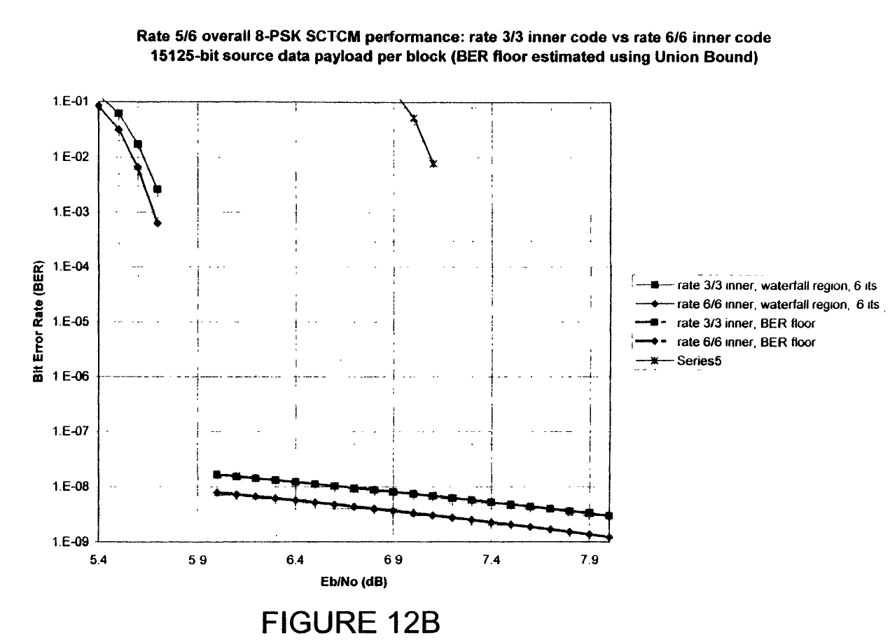

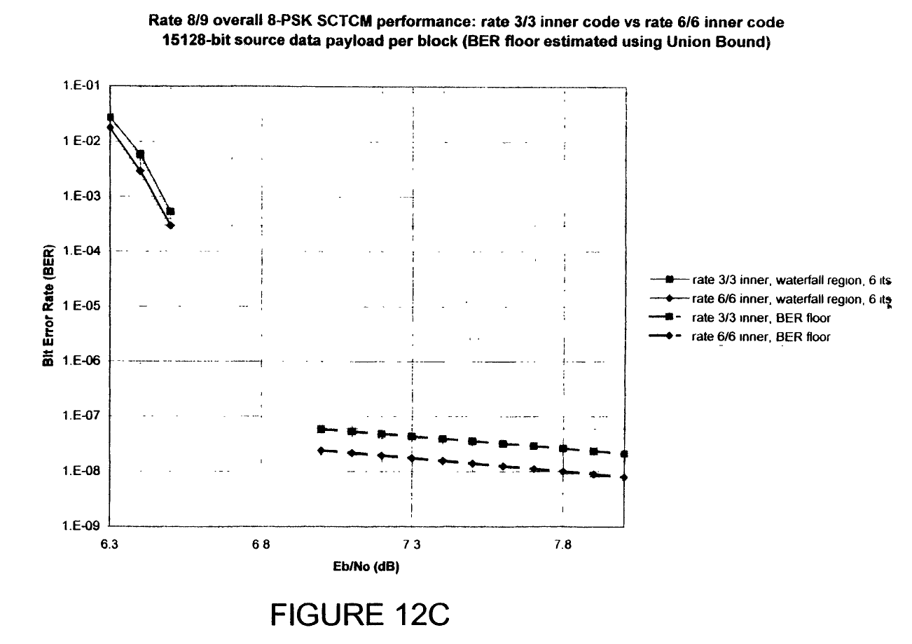

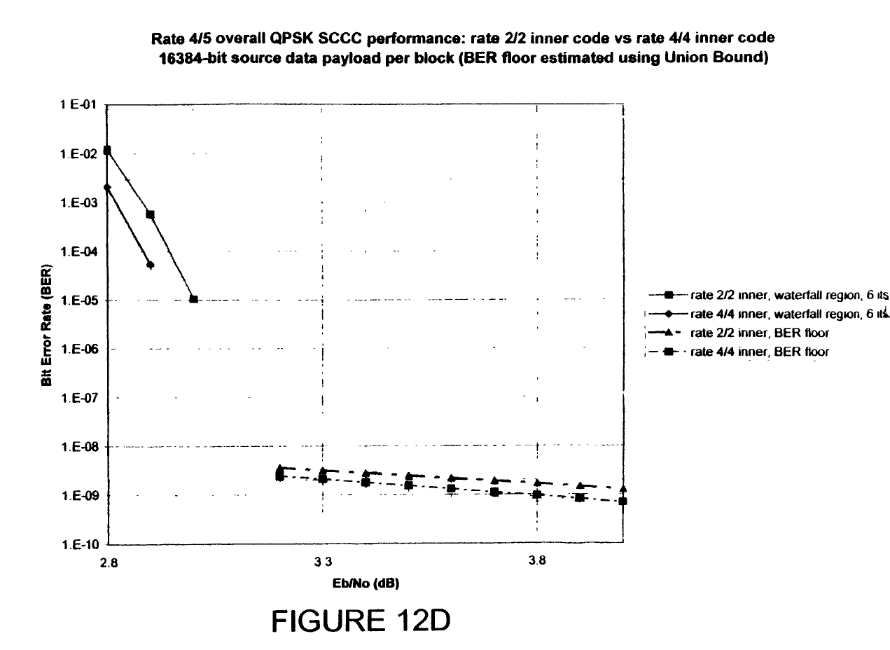

FIG. 12A illustrates the performance of an overall rate ¾ SCTCM encoder with 8-PSK channel symbol mapping, representing an overall throughput of 2.25 bits/symbol. Three different inner codes were simulated: (a) a rate 3/3 code in accordance with the subject invention; (b) a rate 6/6 code in accordance with the subject invention; and (c) a rate 5/6 code. As can be seen, the best performance in the BER floor region (where the operating point will be) is achieved with the rate 6/6 code. The BER floor for this code is about 10⁻⁹. Interestingly, the rate 5/6 code only achieves a BER floor of about 10⁻⁷.

FIG. 12B illustrates the performance of an overall rate 5/6 SCTCM encoder with 8-PSK channel symbol mapping, representing an overall throughput of 2.5 bits/symbol. Two different inner codes were simulated: (a) a rate 3/3 code in accordance with the invention; (b) a rate 6/6 code in accordance with the subject invention; (c) a rate 3/3 code in accordance with the teachings of Divsalar. As illustrated, in the BER floor region, the performance of the rate 6/6 code of the invention slightly exceeds that of the rate 3/3 code of the invention. For the rate 6/6 code, the BER floor ranges between 10⁻⁸ and 10⁻⁹. Note also that while the rate 3/3 code of Divsalar has a lower BER floor, its waterfall performance is almost 1.5 dB worse.

FIG. 12C illustrates the performance of an overall rate 8/9 SCTCM encoder with 8-PSK channel symbol mapping, representing an overall throughput of 2.67 bits/symbol. Two different inner codes were simulated: (a) a rate 3/3 code in accordance with the subject invention; and (b) a rate 6/6 code in accordance with the subject invention. As illustrated, in the BER floor region, the performance of the rate 6/6 code slightly exceeds that of the rate 3/3 code. For the rate 6/6 code, the BER floor is slightly above 10⁻⁸.

FIG. 12D illustrates the performance of an overall rate 4/5 SCTCM encoder with QPSK channel symbol mapping, representing an overall throughput of 1.6 bits/symbol. Two different inner codes were simulated: (a) a rate 2/2 code in accordance with the subject invention; and (b) a rate 4/4 code in accordance with the subject invention. As illustrated, in the BER floor region, the performance of the rate 4/4 code slightly exceeds that of the rate 2/2 code. For the rate 4/4 code, the BER floor is slightly above 10⁻⁹.

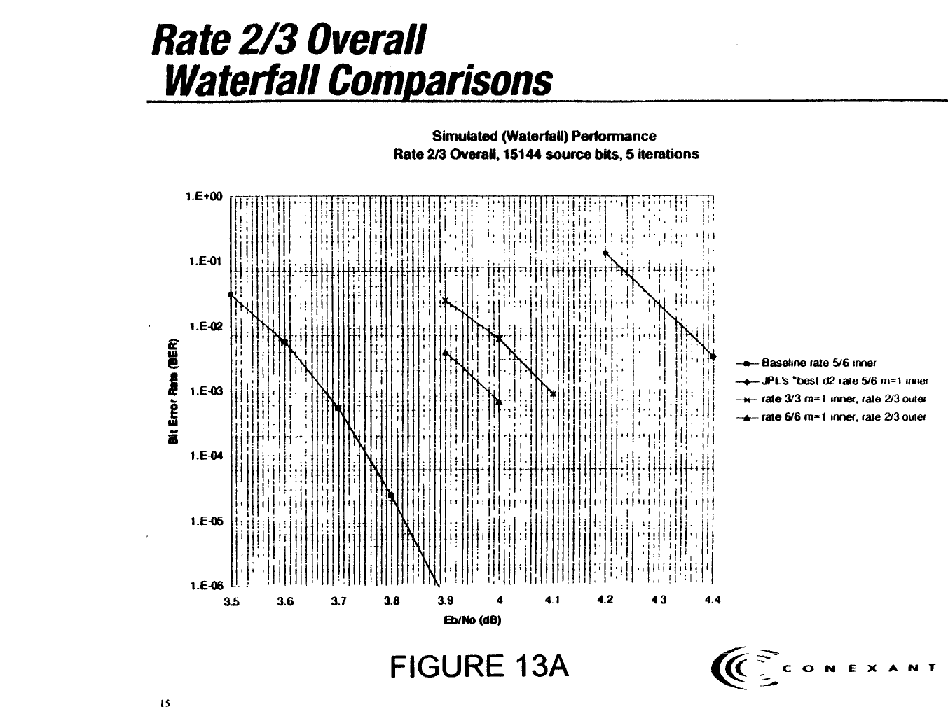

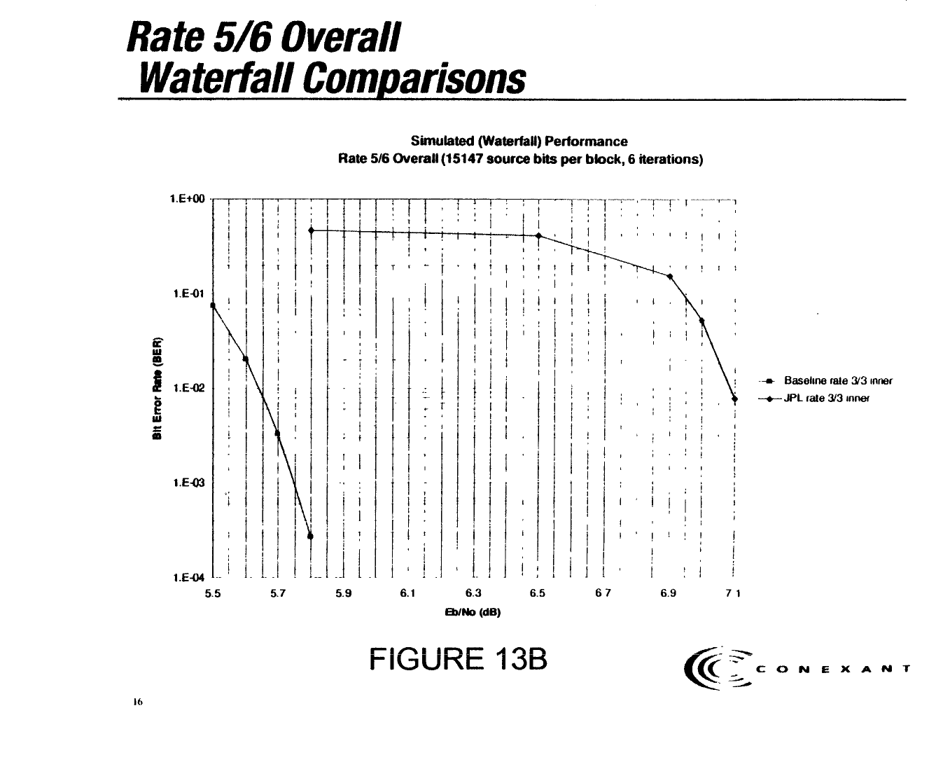

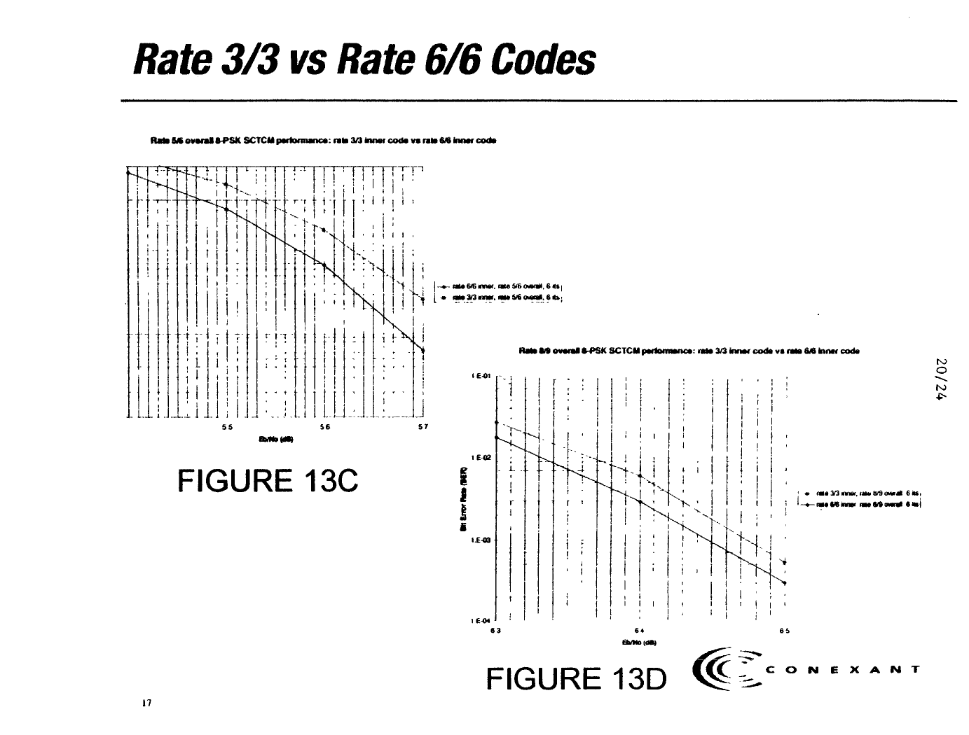

FIG. 13A illustrates the performance of an overall rate 2/3 SCTCM encoder with 8-PSK signal mapping, representing an overall throughput of 2 bits/symbol. Five different inner codes were simulated: (a) a baseline rate 5/6 code in accordance with the teachings of Divsalar; (b) a rate 6/6 code in accordance with the invention; (C) a rate 3/3 code in accordance with the invention; and (d) a “best d2” rate 5/6 code described in Divsalar. Only the performance in the waterfall region was simulated. As illustrated, with the exception of the baseline 5/6 code, the best performance is achieved with the rate 6/6 code of the subject invention. (NOTE: the reference to “m” in the figure refers to the size of the encoder memory, and the reference to iterations refers to the number of iterations that is performed in the turbo decoding process.)

FIG. 13B illustrates the performance of an overall rate 5/6 SCTCM encoder with 8-PSK signal mapping, representing an overall throughput of 2.5 bits/symbol. Two different inner codes were simulated: (a) a baseline rate 3/3 code in accordance with the invention; and (b) a rate 3/3 code described in Divsalar. Only the performance in the waterfall region was simulated. As illustrated, the performance of the baseline rate 3/3 code vastly exceeds that of the rate 3/3 code described in Divsalar.

FIG. 13C illustrates the performance of an overall rate 5/6 SCTCM encoder with 8-PSK signal mapping, representing an overall throughput of 2.5 bits/symbol. Two different inner codes were simulated: (a) a rate 3/3 code in accordance with the invention; and (b) a rate 6/6 code in accordance with the invention. Only the performance in the waterfall region was simulated. As illustrated, the performance of the rate 6/6 code exceeds that of the rate 3/3 code.

FIG. 13D illustrates the performance of an overall rate 8/9 SCTCM encoder with 8-PSK signal mapping, representing an overall throughput of 2.67 bits/symbol. Two different inner codes were simulated: (a) a rate 3/3 code in accordance with the subject invention; and (b) a rate 6/6 code in accordance with the subject invention. As illustrated, the performance of the rate 6/6 code exceeds that of the rate 3/3 code.

While embodiments, implementations, and implementation examples have been shown and described, it should be apparent that there are many more embodiments, implementations, and implementation examples that are within the scope of the subject invention. Accordingly, the invention is not to be restricted, except in light of the appended claims and their equivalents.

What is claimed is:

1. A rate n/n encoder which comprises:
n inputs, wherein n is an integer greater than 1;
n outputs, (n−1) of which are each derived from separate ones of the n inputs; and
logic from which the nth output is derived comprising one or more arithmetic or storage elements coupled together and providing one or more feedback loops from the nth output or some other signal provided by the logic to one or more of the arithmetic or storage elements.

2. The encoder of claim 1 wherein the one or more feedback loops are characterized by a prime polynomial.

3. The encoder of claim 1 wherein (n−1) of the encoder inputs are passed through unaltered to form (n−1) of the encoder outputs.

4. The encoder of claim 1 wherein the logic comprises an adder and storage element, wherein the input of the storage element is coupled to the output of an adder, and the output of the storage element is coupled to an input of the adder, and the nth encoder output is derived from the output of the storage element or the output of the adder.

5. The encoder of claim 4 wherein up to n of the encoder inputs are input to the adder.

6. The encoder of claim 1 in which n is 2.

7. The encoder of claim 1 in which n is 3.

8. The encoder of claim 1 in which n is 4.

9. The encoder of claim 1 in which n is 5.

10. The encoder of claim 1 in which n is 6 or greater.

11. The encoder of claim 1 in combination with a D-dimensional bit to symbol mapper, wherein D is an integer greater than or equal to 1.

12. The combination of claim 11 in which the mapper is a Gray mapper.

13. The combination of claim 12 in which the encoder is a rate 3/3 encoder, and the mapper maps each 3-tuple output from the encoder into an 8-PSK symbol.

14. The combination of claim 12 in which the encoder is a rate 6/6 encoder, and the mapper is a four-dimensional mapper which maps each of the two 3-tuples derived from a 6-tuple output from the encoder into an 8-PSK symbol having I and Q (quadrature) components.

15. The combination of claim 12 in which the encoder is a rate 4/4 encoder, and the mapper maps each 4-tuple output from the encoder into a 16-QAM symbol.

16. The combination of claim 12 in which the encoder is a rate 8/8 encoder, and the mapper is a four-dimensional mapper which maps each of the 4-tuples derived from the 8-tuple output from the encoder into a 16-QAM symbol.

17. The combination of claim 12 in which the encoder is a 12/12 encoder, and the mapper is a six-dimensional mapper which maps each of the 4-tuples derived from the 12-tuple output from the encoder into a 16-QAM symbol.

18. The combination of claim 12 in which the encoder is a rate 8/8 encoder, and the mapper maps each 8-tuple output from the encoder into a 256-QAM symbol.

19. The combination of claim 12 in which the encoder is a rate 12/12 encoder, and the mapper is a four-dimensional mapper which maps each of the 6-tuples derived from the 12-tuple output into a 64-QAM symbol.

20. The combination of claim 12 in which the encoder is a rate 12/12 encoder, and the mapper maps each of the 12-tuples output from the encoder into a 4096-QAM symbol.

21. The combination of claim 11 in which D is greater than or equal to 2 and a multiplexor is coupled to the output of the mapper for serializing the D components of each channel symbol.

22. An SCTCM encoder which includes the combination of claim 11 as its inner encoder.

23. An SCTCM encoder which includes the combination of claim 21 as its inner encoder.

24. An SCCC encoder which includes the encoder of claim 1 as its inner encoder.

25. A transmitter which includes the SCTCM encoder of any of claims 22 or 23.

26. A transmitter which includes the SCCC encoder of claim 24.

27. A transceiver which includes the transmitter of any of claims 25 or 26.

28. The transceiver of claim 27 which is a satellite transceiver.

29. The transceiver of claim 27 which is a wireless transceiver.

30. The transceiver of claim 27 which is a wireline transceiver.

31. A wireless device which includes the transceiver of any of claims 28 or 29.

32. The wireless device of claim 31 which is a mobile wireless device.

33. A method of performing TCM modulation comprising the steps of:
providing an n-tuple of bits as an input to the rate n/n encoder of claim 1, wherein n is an integer greater than 1;
receiving an n-tuple of bits as an output from the encoder; and
mapping the n-tuple of output bits into a D-dimensional channel symbol, wherein D is an integer greater than or equal to 1.

34. The method of claim 33 wherein the mapping step employs Gray mapping.

35. The method of claim 33 wherein D=1.

36. The method of claim 33 wherein D>1.

37. The method of claim 36 further comprising serializing the D components of the channel symbol.

38. The combination of claim 12 in which the encoder is a rate 2/2 encoder, and the mapper maps each 2-tuple output from the encoder into two QPSK symbols.

39. The combination of claim 12 in which the encoder is a rate 4/4 encoder, and the mapper maps each of the two 2-tuples derived from the 4-tuple output from the encoder into a QPSK symbol having I and Q components.

40. A method of performing TCM modulation comprising the following steps:
providing a k-tuple of bits as an input to an outer encoder comprising a convolutional encoder having redundancy, the outer encoder producing an n-tuple of bits, where both n and k are integers and n>k;
passing the n-tuple of bits through an interleaver, which outputs an n-tuple of interleaved bits;
providing the n-tuple of interleaved bits as input to an inner encoder comprising the rate n/n encoder of claim 1;
receiving an n-tuple of output bits from the inner encoder; and
mapping the n-tuple of output bits into a D-dimensional channel symbol, where D is an integer greater than or equal to 1.

41. A method of performing SCC modulation comprising the following steps:
providing a k-tuple of bits as an input to an outer encoder comprising a convolutional encoder having redundancy, the outer encoder producing an n-tuple of bits, where both n and k are integers and n>k;
passing the n-tuple of bits through an interleaver, which outputs an n-tuple of interleaved bits;
providing the n-tuple of interleaved bits as input to an inner encoder comprising the rate n/n encoder of claim 1;
receiving an n-tuple of output bits from the inner encoder; and
mapping the n-tuple of output bits into a QPSK or BPSK channel symbol.

42. A method of decoding channel symbols comprising the steps of:
receiving channel symbols as produced by the method of any of claims 40 or 41 after transmission over a channel;
providing the channel symbols through an inner decoder which receives first a priori information and produces first a posteriori information from the channel symbols and the first a priori information;
passing the first a posteriori information through a de-interleaver to produce second a priori information for an outer decoder;
inputting the second a priori information to the outer decoder which produces second a posteriori information;
passing the second a posteriori information from the outer decoder through an interleaver to produce the first a priori information input to the inner decoder;
iterating through the foregoing steps a prescribed number p of iterations, where p is an integer greater than or equal to 1; and
after the prescribed number p of iterations, forming estimates of source bits from third a posteriori information provided by the outer decoder.

43. A SCTCM decoder embodying the method steps of claim 42.

44. A SCCC decoder embodying the method steps of claim 41.

45. A system which comprises a transmitter including the SCTCM encoder of any of claims 22 or 23, and one or more receivers each including the SCTCM decoder of claim 43, the transmitter configured to broadcast information to the one or more receivers over a transmission link.

46. The system of claim 45 wherein the link is a wireless link.

47. The system of claim 45 wherein the link is a wireline link.

48. The system of claim 45 wherein the link is a satellite link.

49. A system which comprises a transmitter including the SCCC encoder of claim 24, and one or more receivers each including the SCCC decoder of claim 44, the transmitter configured to broadcast information to the one or more receivers over a transmission link.

50. The combination of claim 12 in which the encoder is a rate 10/10 encoder, and the mapper is a two-dimensional mapper which maps each 10-tuple output from the encoder into a 1024-QAM channel symbol.

51. The combination of claim 12 in which the encoder is a rate 20/20 encoder, and the mapper is a four-dimensional mapper which maps each of the 10-tuples derived from a 20-tuple output from the encoder into a 1024-QAM channel symbol.

52. The combination of claim 12 in which the encoder is a rate 60/60 encoder, and the mapper is a six-dimensional mapper which maps each of the 10-tuples derived from a 60-tuple output from the encoder into a 1024-QAM symbol.

53. The combination of claim 12 in which the encoder is a rate 9/9 encoder, and the mapper is a six-dimensional mapper which maps each of the three-tuples derived from a 9-tuple output from the encoder into an 8-PSK channel symbol.

54. A rate n/n encoder which comprises:
n inputs, wherein n is an integer greater than 1;
n outputs, (n−1) of which are each derived from separate ones of the n inputs; and
logic means for providing the nth output of the encoder, and providing one or more feedback loops from the nth output or some other signal provided by the logic means to one or more of the arithmetic or storage elements.

55. The encoder of claim 54 wherein the one or more feedback loops are characterized by a prime polynomial.

56. A method of performing TCM modulation comprising:
a step for providing an n-tuple of bits as an input to the rate n/n encoder of claim 54, wherein n is an integer greater than 1;
a step for receiving an n-tuple of bits as an output from the encoder; and
a step for mapping the n-tuple of output bits into a D-dimensional channel symbol, wherein D is an integer greater than or equal to 1.

57. A method of performing TCM modulation comprising:
a step for providing a k-tuple of bits as an input to an outer encoder comprising a convolutional encoder having redundancy, the outer encoder producing an n-tuple of bits, where both n and k are integers and n>k;
a step for passing the n-tuple of bits through an interleaver, which outputs an n-tuple of interleaved bits;
a step for providing the n-tuple of interleaved bits as input to an inner encoder comprising the rate n/n encoder of claim 54;
a step for receiving an n-tuple of output bits from the inner encoder; and
a step for mapping the n-tuple of output bits into a D-dimensional channel symbol, where D is an integer greater than or equal to 1.

58. A method of performing SCC modulation comprising:
a step for providing a k-tuple of bits as an input to an outer encoder comprising a convolutional encoder having redundancy, the outer encoder producing an n-tuple of bits, where both n and k are integers and n>k;
a step for passing the n-tuple of bits through an interleaver, which outputs an n-tuple of interleaved bits;
a step for providing the n-tuple of interleaved bits as input to an inner encoder comprising the rate n/n encoder of claim 54;
a step for receiving an n-tuple of output bits from the inner encoder; and
a step for mapping the n-tuple of output bits into a QPSK or BPSK channel symbol.

59. A method of decoding channel symbols comprising:
a step for receiving channel symbols as produced by the method of any of claims 57 or 58 after transmission over a channel;
a step for providing the channel symbols through an inner decoder which receives first a prior information and produces first a posteriori information from the channel symbols and the first a priori information;
a step for passing the first a posteriori information through a de-interleaver to produce second a priori information for an outer decoder;
a step for inputting the second a priori information to the outer decoder which produces second a posteriori information;
a step for passing the second a posteriori information from the outer decoder through an interleaver to produce the first a priori information input to the inner decoder;
a step for iterating through the foregoing steps a prescribed number p of iterations, where p is an integer greater than or equal to 1; and
a step for forming, after the prescribed number p of iterations, estimates of source bits from third a posteriori information provided by the outer decoder.
